(19) United States
(12) Patent Application Publication
(10) Pub. No.: US 2007/0130755 A1
(43) Pub. Date: Jun. 14, 2007

(54) Electronics assembly machine with embedded solder paste inspection

(76) Inventors: David W. Duquette, Minneapolis, MN (US); John P. Konicek, Minneapolis, MN (US); Steven K. Case, St. Louis Park, MN (US); Eric P. Rudd, Hopkins, MN (US); Swaminathan Manickam, Bellingham, MA (US)

Correspondence Address: Christopher R. Christenson;C/O WESTMAN, CHAMPLIN & KELLY, P.A., Suite 1400, 900 Second Avenue South, Minneapolis, MN, 55402-3319, US

(21) Appl. No.: 11/590,680

(22) Filed: Oct. 31, 2006

Related U.S. Application Data
(60) Provisional application No. 60/731,848, filed on Oct. 31, 2005.

(51) Int. Cl. B23K 31/02

(52) U.S. Cl. 29/740; 29/720; 29/721; 29/745; 228/180.21; 228/180.22; 29/833

(57) ABSTRACT

A pick and place machine includes a placement head configured to releasably grasp a component for placement. A robotic system is coupled to the placement head to generate relative movement between the placement head and a workpiece. An image acquisition system is configured to acquire at least one image of an intended placement location of the component before the component is placed. A controller is operably coupled to the image acquisition system, the controller is configured to process at least one before-placement image to generate a metric relative to solder deposited at the intended placement location.

### CROSS-REFERENCE TO RELATED APPLICATION

The present application is based on and claims the benefit of U.S. provisional patent application Ser. No. 60/731,848, filed Oct. 31, 2005, which application is herein incorporated by reference in its entirety.

### COPYRIGHT RESERVATION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Pick and place machines are generally used to manufacture electronic circuit boards. A blank printed circuit board is usually supplied to the pick and place machine, which then picks electronic components from component feeders, and places such components upon the board. The components are held upon the board temporarily by solder paste or adhesive until a subsequent step in which the solder paste is melted, or the adhesive is fully cured.

Pick and place machine operation is challenging. Since machine speed corresponds with throughput, the faster the pick and place machine runs, the less costly the manufactured board. Additionally, placement accuracy is extremely important. Many electrical components, such as chip capacitors and chip resistors are relatively small and must be accurately placed on equally small placement locations. Other components, while larger, have a significant number of leads or conductors that are spaced from one another at a relatively fine pitch. Such components must also be accurately placed to ensure that each lead is placed upon the proper pad. Thus, not only must the machine operate extremely fast, but it must also place components extremely accurately.

In order to enhance the quality of board manufacture, fully or partially populated boards are generally inspected after the placement operation(s), both before and after solder reflow, in order to identify components that are improperly placed or missing or any of a variety of errors that may occur. Automatic systems that perform such operation(s) are highly useful in that they help identify component placement problems prior to solder reflow allowing substantially easier rework or identify defective boards after reflow that are candidates for rework. One example of such a system is sold under the trade designation Model KS Flex available from CyberOptics Corporation of Golden Valley, Minn. This system can be used to identify such problems as alignment and rotation errors; missing and flipped components; billboards, where the part lays improperly on its longer side edge; tombstones, where the part lays improperly on its shorter edge; partial billboards and tombstones, where the part is oriented between its normal orientation and a billboard or tombstone orientation; component defects; incorrect polarity; and wrong components. Identification of errors pre-reflow provides a number of advantages. Rework is easier; closed-loop manufacturing control is facilitated; and less work in-process exists between error generation and remedy. While such systems provide highly useful inspection, they do consume plant floor-space as well as programming time, maintenance efforts and the like.

One relatively recent attempt to provide the benefits of after-placement inspection located within a pick a place machine itself is disclosed in U.S. Pat. No. 6,317,972 to Asai et al. That reference reports a method for mounting electric components where an image of a mounting location is obtained prior to component placement, and compared with an image of the mounting location after component placement to inspect the placement operation at the component level. While the disclosure of Asai et al. marks one attempt to employ in-machine component level inspection to inspect the component placement operation, component orientation errors can also be generated in the process of picking up a component. This process remains a challenge and a major contributor to the quality of the overall operation of the pick and place machine.

The utilization of solder paste to temporarily hold a component upon a circuit board, and later electrically and mechanically couple the component to the circuit board is critical to modern electronics assembly operations. For example, if the solder paste of a single pad of a single component is not placed correctly, it may fail to generate the requisite electrical contact between the component and the circuit board. Further, even a correctly-placed solder pad which is placed simply with far too much solder paste may erroneously generate an electrical connection between two adjacent portions of the circuit board thereby generating an undesirable short circuit. Further still, characteristics of the solder paste and/or pads of the component may affect the ability of the solder paste to temporarily retain the component upon the workpiece until the solder is finally melted to form the permanent connection.

Generally, solder paste for an entire printed circuit board is applied in a screen printing operation. A screen containing a negative image of the circuit board's solder pads is brought into proximity with the circuit board, and solder paste is essentially squeezed through the screen to generate the individual deposits. Sometimes, solder may get stuck, or otherwise lodged within individual apertures of the screen. If this occurs, the solder paste may simply not be present at a certain portion of the circuit board. In order to ensure that solder paste is deposited correctly, solder paste inspection machines are sometimes used in the assembly line. One example of such a solder paste inspection machine is sold under the trade designation SE 300™ Ultra available from CyberOptics Corporation of Golden Valley, Minn. However, even state-of-the-art, advanced, solder paste inspection machines still require a relatively significant capital investment, as well as the occupation of precious floor space in an electronics assembly plant. Providing solder paste inspection functions without requiring the use of the dedicated solder paste inspection machine would significantly benefit the art of electronics assembly.

### SUMMARY

A pick and place machine includes a placement head configured to releasably grasp a component for placement. A robotic system is coupled to the placement head to generate relative movement between the placement head and a workpiece. An image acquisition system is configured to acquire at least one image of an intended placement location of the component before the component is placed. A controller is operably coupled to the image acquisition system, the controller is configured to process at least one before-placement image to generate a metric relative to solder deposited at the intended placement location.

### BRIEF DESCRIPTION OF THE DRAWINGS

FIG. 1 is a diagrammatic view of a Cartesian pick and place machine with which embodiments of the invention can be practiced.

FIG. 2 is a diagrammatic plan view of a turret pick and place machine with which embodiments of the invention can be practiced.

FIG. 3 is a diagrammatic view of a component temporarily retained upon nozzle of placement head of a pick and place machine.

FIG. 4 is an exemplary diagrammatic before-placement image of a particular component placement location.

FIG. 5 is an exemplary view illustrating only a pair of solder paste deposits that will retain a chip resistor.

FIG. 6 is a flow diagram of a method of operating an electronics assembly machine in accordance with an embodiment of the present invention.

### DETAILED DESCRIPTION OF ILLUSTRATIVE EMBODIMENTS

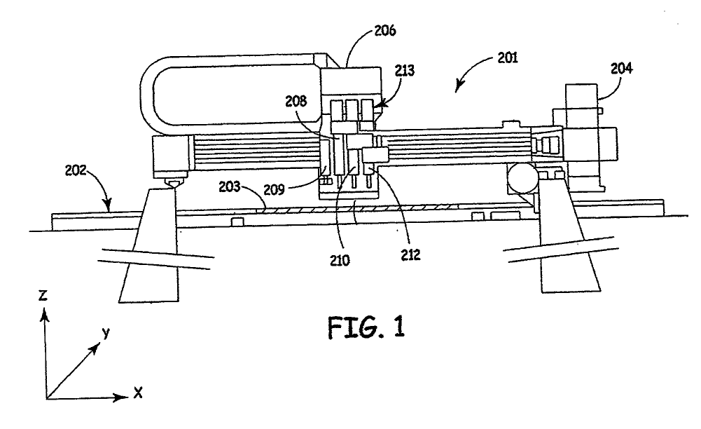

FIG. 1 is a diagrammatic view of an exemplary Cartesian pick and place machine 201 with which embodiments of the present invention are applicable. Pick and place machine 201 receives a workpiece, such as circuit board 203, via transport system or conveyor 202. A placement head 206 then obtains one or more electrical components to be mounted upon circuit board 203 from component feeders (not shown) and moves in x, y and z directions to place the component in the proper orientation at the proper location upon circuit board 203. Placement head 206 may include multiple nozzles 208, 210, 212 to pick multiple components. Some pick and place machines may employ a placement head that moves over a stationary camera to image the component(s) in order to ascertain component location and orientation upon each nozzle. The placement head 206 may also include a downwardly looking camera 209, which is generally used to locate fiducial marks upon circuit board 203 such that the relative location of placement head 206 with respect to circuit board 203 can be readily calculated.

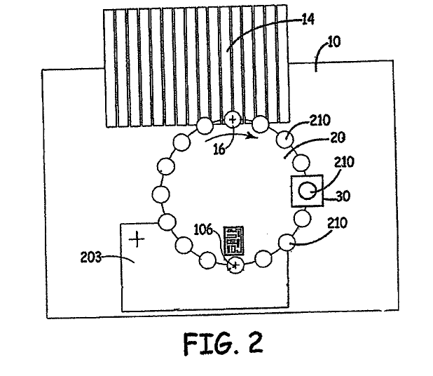

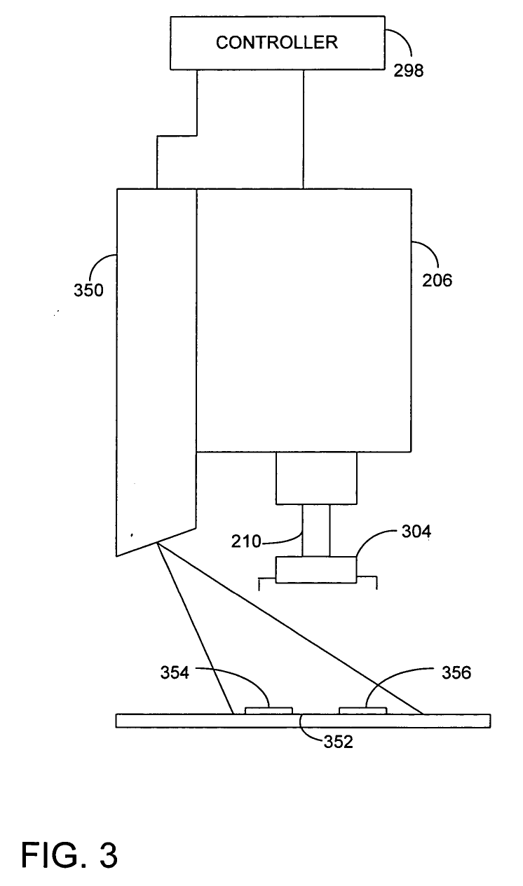

FIG. 2 is a diagrammatic view of an exemplary rotary turret pick and place machine 10 with which embodiments of the present invention are also applicable. Machine 10 includes some components that are similar to machine 201 and like components are numbered similarly. For turret pick and place machine 10, circuit board 203 is loaded via a conveyor onto an x-y stage (not shown). Attached to main turret 20, are nozzles 210 that are disposed at regular angular intervals around the rotating turret. During each pick and placement cycle, turret 20 indexes an angular distance equal to the angular distance between adjacent placement nozzles 210. After turret 20 rotates into position and circuit board 203 is positioned by the x-y stage, a placement nozzle 210 obtains a component 304 (shown in FIG. 3) from a component feeder 14 at a defined pick point 16. During this same interval, another nozzle 210 places a component 304 onto the circuit board 203 at a preprogrammed placement location 106. Additionally, while turret 20 pauses for the pick and place operation, upward looking camera 30 acquires and image of another component 304, which provides alignment information for that component. This alignment information is used by pick and place machine 10 to position circuit board 203 when placement nozzle 210 is positioned several steps later to place component 304. After the pick and place cycle is complete, turret 20 indexes to the next angular position and circuit board 203 is repositioned in x-y direction(s) to move the placement location to position which corresponds to the placement location 106.

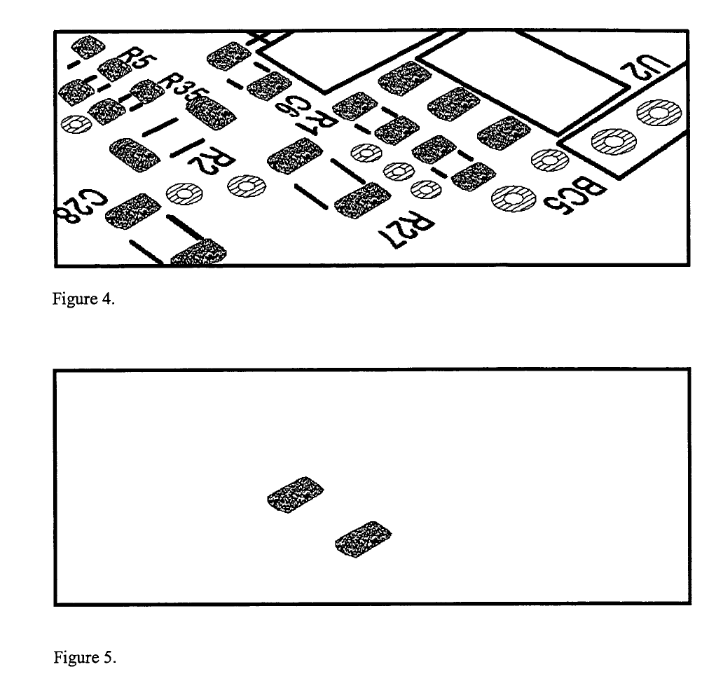

FIG. 3 is a diagrammatic view of a component 304 temporarily retained upon nozzle 210 of placement head 206 of a pick and place machine. Image acquisition system 350 is preferably coupled to, or otherwise integrated with, placement head 206 and is disposed to acquire an image of placement location 352 prior to placement of component 304 upon location 352. System 350 is coupled to, or contains, a suitable controller 298 for processing images obtained by system 350. Controller 298 may be the controller for the entire pick and place machine, and in which case, controller 298 is also coupled to placement head 206. System 350 can be in accordance with any of the image acquisition systems currently used in embedded component inspection-based systems such as those disclosed in U.S. patent application Ser. No. 10/291,074, filed Nov. 8, 2002, entitled PICK AND PLACE MACHINE WITH COMPONENT PLACEMENT INSPECTION; Ser. No. 10/970,355, filed Oct. 21, 2004, entitled PICK AND PLACE MACHINE WITH IMPROVED COMPONENT PLACEMENT INSPECTION; Ser. No. 10/978,687, filed Nov. 21, 2004, entitled PICK AND PLACE MACHINE WITH IMPROVED WORKPIECE INSPECTION; Ser. No. 10/979,750, filed Nov. 2, 2004, entitled PICK AND PLACE MACHINE WITH IMPROVED SETUP OPERATION PROCEDURE; Ser. No. 11/131,926, filed May 18, 2005, entitled IMAGE ANALYSIS FOR PICK AND PLACE MACHINES WITH IN SITU COMPONENT PLACEMENT INSPECTION; and Ser. No. 11/185,920, filed Jul. 20, 2005, entitled PICK AND PLACE MACHINE WITH IMPROVED INSPECTION. As illustrated diagrammatically in FIG. 3, location 352 includes a plurality of solder paste deposits 354, 356. These solder paste deposits 354, 356 are clearly evident to image acquisition system 350 in any images acquired of location 352 prior to the placement of component 304 thereon. For example, FIG. 4 provides one exemplary diagrammatic before-placement image of a particular component placement location labeled R27. A pair of solder paste deposits are evident in order to receive a chip resistor labeled R27. Using any suitable image analytics, or processing techniques, individual solder paste deposits of interest can be isolated for more advanced analysis. For example, FIG. 5 is an exemplary diagrammatic view illustrating only the pair of solder paste deposits that will retain chip resistor R27. FIG. 5 is one exemplary illustration of how solder paste can be segmented from other features present in the before-placement image using any of a variety of algorithms that make use of distinguishing aspects of the solder paste appearance. The solder paste deposits for R27 can be evaluated and any suitable metrics can be calculated. For example, suitable metrics include size and shape of the solder paste deposits. Additionally, or in the alternative, the after-placement image of a placed component can be used to highlight, or otherwise detect, a difference in the particular solder paste deposits of interest. For example, while all solder paste deposits within the field of you will be viewable in the before-placement image, those solder paste deposits covered by the placed component will be obscured in the later-acquired after-placement image. Accordingly, contrasting the before-placement image with the after-placement image can generate an area of interest that when applied to the before-placement image effectively segments the solder paste deposits of interest. Certainly, other techniques can be used for segmenting, or otherwise focusing upon, solder paste deposits of interest.

In accordance with one embodiment of the present invention, a single before-placement image of the placement location is acquired. This single before-placement image can be used to perform two-dimensional image analysis upon the solder paste. Such analysis can be useful in determining whether the solder paste is applied at the correct position, and/or whether the correct amount of solder paste has been applied, to the extent that the amount of solder paste affects the length and width of the solder paste deposit. However, it is also contemplated that a plurality of before-placement images could be acquired each image being from a different point of view. Thus, a plurality of image acquisition systems 350 could be used, with each system 350 observing location 352 from a different point of view. When the plurality of image acquisition systems acquire their respective before-placement images, the two, or more images, can be used to provide depth information in accordance with known stereo vision processing techniques. Examples of the utilization of multiple image acquisition systems for providing depth information related to embedded component inspection in a pick and place machine can be found in U.S. patent application Ser. No. 10/291,074, filed Nov. 8, 2002, entitled PICK AND PLACE MACHINE WITH COMPONENT PLACEMENT INSPECTION.

In the alternative, each and/or both of a plurality of image acquisition systems can include a structured illuminator able to provide structured illumination upon placement location 352. The utilization of structured illumination includes the utilization of laser light, and/or the utilization of light, the intensity of which, varies in accordance with a set pattern, such as a sinusoidal fringe pattern. Providing structured light upon location 352 allows for depth information to be derivable using a single before-placement image from a single image acquisition system. Accordingly, embodiments of the present invention, are able to derive information not only relative to the two-dimensional solder paste length and width, but also relative to the height. In this manner, the total volume of the solder paste deposited can be calculated and compared to a priori information to ensure not only that sufficient solder paste has been deposited, but also to that too much solder paste has not been deposited.

In accordance with another embodiment of the present invention, since the solder paste inspection occurs in real-time slightly before components are placed, the placement of individual components can be varied in response to individual solder paste inspection results. For example, if a pair of solder paste deposits are slightly misplaced, such as skewed in one direction, the placement of the component can similarly be skewed such that the component rests squarely upon the slightly misplaced solder deposits. In this manner, the electrical and mechanical connection to the solder paste deposits themselves is far more robust than if the component were placed in its nominal position upon the slightly misplaced solder paste deposits. It is therefore believed that embodiments of the present invention may actually improve the robustness of electronics devices without requiring significantly more capital investment, or increasing pick and place machine throughput time than current state-of-the-art electronics assembly machines.

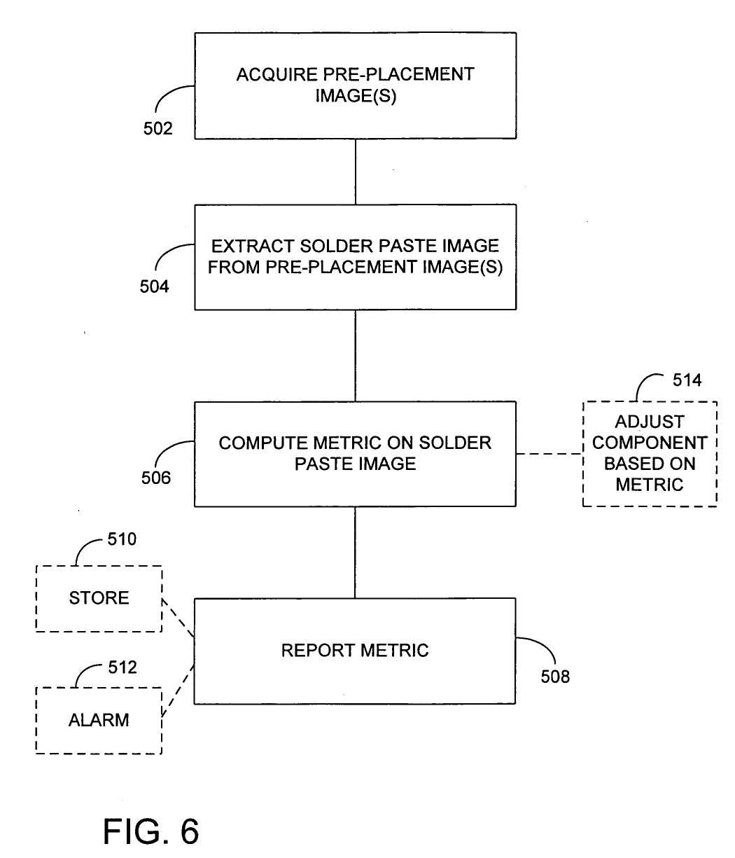

FIG. 6 is a flow diagram of a method of operating an electronics assembly machine in accordance with an embodiment of the present invention. Method 500 begins at block 502 where at least one pre-placement image of an intended placement location within a pick and place machine is acquired. Next, at block 504, solder paste image(s) is/are extracted from the pre-placement image(s). As set forth above, the manner in which the solder paste image(s) is/are extracted from the pre-placement image can take any suitable form. Next, at block 506, a metric relative to the solder paste image is computed. Examples of suitable metrics include position of the solder paste deposit, length of the solder paste deposit, width of the solder paste deposit, height of the solder paste deposit, volume of the solder paste deposit, or any combination thereof. At block 508, the metric computed in block 506 is reported. Examples of such reporting include storing 510 the metric for later analysis and/or verification. Further, reporting the metric can take the form of generating a suitable alarm 512. As indicated at block 514, in phantom, the component placement can be adjusted based upon the metric computed in block 506. Thus, as indicated at block 514, component placement is optionally adjusted based upon the metric. Examples of such adjustment include generating a deviation from an otherwise-programmed placement location based upon the computed metric; and/or aborting the component placement operation all together.

Although the present invention has been described with reference to preferred embodiments, workers skilled in the art will recognize that changes may be made in form and detail without departing from the spirit and scope of the invention.

What is claimed is:

1. A pick and place machine comprising:
a placement head configured to releasably grasp a component for placement;
a robotic system coupled to the placement head to generate relative movement between the placement head and a workpiece;
an image acquisition system configured to acquire at least one image of an intended placement location of the component before the component is placed; and
a controller operably coupled to the image acquisition system, the controller being configured to process the at least one image to generate a metric relative to solder paste deposited at the intended placement location.

2. The pick and place machine of claim 1, wherein the metric is width of a solder paste deposit.

3. The pick and place machine of claim 1, wherein the metric is length of a solder paste deposit.

4. The pick and place machine of claim 1, wherein the metric is position of a solder paste deposit on the workpiece.

5. The pick and place machine of claim 4, wherein the controller is further configured to adjust component placement based upon the position of the solder paste deposit.

6. The pick and place machine of claim 5, wherein adjusting component placement comprises generating a deviation from an otherwise preprogrammed placement location.

7. The pick and place machine of claim 5, wherein adjusting component placement comprises aborting a placement operation.

8. The pick and place machine of claim 1, wherein the image acquisition system includes a structured illuminator, and wherein the metric is height of a solder paste deposit.

9. The pick and place machine of claim 8, wherein the controller is configured to calculate volume of a solder paste deposit based upon the height.

10. The pick and place machine of claim 9, wherein the calculated volume is compared with a priori information to determine if the deposit is acceptable.

11. The pick and place machine of claim 8, wherein the structured illuminator generates laser illumination.

12. The pick and place machine of claim 8, wherein the structured illuminator generates illumination having a patterned variation in intensity.

13. The pick and place machine of claim 12, wherein the illumination is a sinusoidal fringe pattern.

14. The pick and place machine of claim 1, wherein the image acquisition system is mounted to the placement head.

15. A method of inspecting a solder paste deposit on a printed circuit board using a pick and place machine, the method comprising:
obtaining at least one pre-placement image of an intended placement location on the printed circuit board;
extracting a portion of the pre-placement image related to a solder paste deposit; and
calculating at least one metric related to the solder paste deposit.

16. The method of claim 15, wherein the metric is width of the solder paste deposit.

17. The pick and place machine of claim 15, wherein the metric is length of the solder paste deposit.

18. The pick and place machine of claim 15, wherein the metric is position of the solder paste deposit on the workpiece.

19. The method of claim 15, and further comprising adjusting placement of a component, prior to placing the component, based upon the at least one metric.

20. A pick and place machine comprising:
a placement head configured to releasably grasp a component for placement;
a robotic system coupled to the placement head to generate relative movement between the placement head and a workpiece; and
means for optically inspecting a solder paste deposit on the workpiece.
